(19) United States
(12) Patent Application Publication
(10) Pub. No.: US 2025/0258467 A1
(43) Pub. Date: Aug. 14, 2025

(54) COMPUTER-IMPLEMENTED METHOD FOR GENERATING A COMPLEXITY-REDUCED TIME MODEL OF A DISTRIBUTED SYSTEM

(71) Applicant: Robert Bosch GmbH, Stuttgart (DE)

(72) Inventors: Stephan Rhode, Karlsruhe (DE); Joachim Hoffmann, Fellbach (DE); Kevin Schmidt, Herrenberg (DE)

(21) Appl. No.: 19/047,309

(22) Filed: Feb. 6, 2025

(30) Foreign Application Priority Data
Feb. 9, 2024 (DE) 10 2024 201 223.8

(51) Int. Cl. G05B 17/02

(52) U.S. Cl. CPC G05B 17/02

(57) ABSTRACT

A method for generating a complexity-reduced time model of a distributed system. The method includes receiving time data, receiving a control path model and modeling the received time data as a stochastic process in order to obtain an original stochastic process. The method furthermore includes decomposing the original stochastic process into a plurality of modes of the original stochastic process, in order to obtain an approximation of the original stochastic process. The method includes performing a sensitivity analysis using the control path model and the approximation. The method furthermore includes selecting a first subset of modes of the approximation on the basis of the comparison and/or a default value, and outputting a complexity-reduced time model on the basis of the first subset of the modes.

### BACKGROUND INFORMATION

Highly automated or autonomous systems are increasingly in focus, for example, in robotics and in the automotive sector. Especially control systems are becoming increasingly important in the operation of autonomous or highly automated systems.

Difficulties arise when stochastically distributed parameters are taken into account. Taking stochastically uncertain path parameters into account in the design of controllers, for example through intrusive uncertainty quantification methods, is conventional. An example of such a stochastically uncertain parameter is the uniform distribution of the vehicle mass in vehicle dynamics models. The uncertainties discussed in the related art are always assumed to be time-independent, scalar quantities. For example, if a plurality of uncertainties occur, they are still assumed to be uncorrelated.

Problems arise in distributed systems in which, for example, the control algorithm is executed physically separately from the system to be controlled, for example by means of cloud computing or edge computing, which results in time delays in data transmission. Many related-art solutions do not adequately take into account the influence of uncertain time effects and their representation in the control. Examples of such time effects are jitter, delay, and/or degradation.

Due to different physical conditions that influence signal transmission or due to different channel utilization in vehicle-to-vehicle communication (V2V communication), time delays or fluctuating sampling times may occur, which are non-deterministic and therefore uncertain. For example, networked adaptive cruise control, group starts or cooperative lane merging can be situations in which channel utilization is unusually high in comparison to other situations. For example, non-deterministic delays can arise in the feedback loop, in bus communication when distributed E/E architectures are involved in vehicle control functions, and/or in signal processing and signal transmission in sensor systems. In control systems, such as the longitudinal guidance of a vehicle, the non-deterministic time delay can have a detrimental effect on the success of the control. As a result, the systems under consideration must either be tuned very conservatively or optimized through worst-case analyses, which can lead to poor performance. There is therefore a need for improved methods for quantifying and taking into account stochastically distributed time effects in the design of controllers.

### SUMMARY

A first general aspect of the present invention relates to a method for generating a complexity-reduced time model of a distributed system. According to an example embodiment of the present invention, the method comprises receiving time data, receiving a control path model and modeling the received time data as a stochastic process in order to obtain an original stochastic process. The method furthermore comprises decomposing the original stochastic process into a plurality of modes of the original stochastic process, in order to obtain an approximation of the original stochastic process. The method comprises performing a sensitivity analysis using the control path model and the approximation. The method furthermore comprises selecting a first subset of modes of the approximation on the basis of the comparison and/or a default value, and outputting a complexity-reduced time model on the basis of the first subset of the modes.

A second general aspect of the present invention relates to a computer system designed to execute the method for generating a complexity-reduced time model of a distributed system according to the first general aspect of the present invention (or an embodiment thereof).

A third general aspect of the present invention relates to a computer program designed to execute the method for generating a complexity-reduced time model of a distributed system according to the first general aspect (or an embodiment thereof).

A fourth general aspect of the present invention relates to a computer-readable medium or signal that stores and/or contains the computer program according to the third general aspect of the present invention (or an embodiment thereof).

The method according to the first general aspect of the present invention (or an embodiment thereof) disclosed herein can be used to provide a method for generating a complexity-reduced time model of a distributed system. The method can be used to determine a complexity-reduced time model for the design of a state controller.

By reducing the complexity, the method according to the present invention can make it possible that the generated time model is suitable for implementation in a controller and that a controller evaluation can be performed online, i.e., in real time. A further advantage of the method of the present invention can be seen in the fact that it utilizes the correlation between the time courses of the time effects and makes less conservative controller designs possible. The method can make it possible to distribute the control system across a plurality of physically separate components and to take into account the resulting time effects, for example in the design of a controller. The complexity-reduced time model can be applied, for example, in a controller design based on uncertainty quantification. For example, the complexity-reduced time model can make it possible for only one or a few simulations to be necessary to characterize the influence of uncertain time effects on a control system, which can represent a significant efficiency gain in comparison to a large number of simulations by means of inefficient UQ methods. This can lead to savings in terms of runtime on the one hand and, on the other hand, in terms of the computer resources required for the simulation.

Furthermore, the techniques of the present invention can represent the uncertain time effects in a data transmission channel and/or take into account the uncertain time effects in the sampling of transmitted signals.

One advantage is that the method of the present invention can be applied to a wide variety of control systems. An example in this respect could be the longitudinal guidance of a vehicle. The longitudinal guidance of a vehicle refers to the control and stability of its motion along the direction of travel. It can comprise aspects such as acceleration, deceleration and cruise control, which ensure that the vehicle can move forward or backward on the road in the desired manner. Particularly with regard to autonomous and/or assisted driving, in which a plurality of vehicles communicate via the same communication points and delays in data transmission can occur, for example, during group starts (e.g., “traffic light starts”), the techniques of the present disclosure can lead to improved control behavior. In this context, the method of the present invention can also lead to improved control of the vehicle's lateral guidance.

Further examples can be found in the various fields of control engineering, such as robotics, motor control of electric machines, building automation, etc. The method can be provided in a further encapsulated form and can thus make use by an extended user group possible, even if this user group or individual members of the user group do not know the underlying mathematical principles. Integration into an existing software structure can also be made possible.

Some terms are used in the present disclosure in the following way:

A “state controller” can comprise an algorithm, i.e., a calculation rule, which returns a complete or partial state variable (i.e., the internal state of the control path) to an input variable. A state controller can comprise parameters which can weight the state variable. In examples, a state controller can be executed on a computer system. In examples, a state controller can be executed in a control unit of a vehicle, a cloud or an edge. A state controller can, for example, comprise or be part of a hardware module with inputs and outputs.

A “vehicle” can be any device that transports passengers and/or freight. A vehicle can be a motor vehicle (for example a passenger car or a truck), but also a rail vehicle. A vehicle can also be a motorized two-wheeler or three-wheeler. However, floating and flying devices can also be vehicles. Vehicles can be operating or assisted at least partially autonomously.

### BRIEF DESCRIPTION OF THE DRAWINGS

FIG. 1 schematically illustrates a method for generating a complexity-reduced time model of a distributed system, according to an example embodiment of the present invention.

FIG. 2 schematically illustrates an exemplary architecture for executing the method for generating a complexity-reduced time model, according to an example embodiment of the present invention.

FIG. 3A to 3D illustrate exemplary results of the sensitivity analysis for individual modes, according to an example embodiment of the present invention.

### DETAILED DESCRIPTION OF EXAMPLE EMBODIMENTS

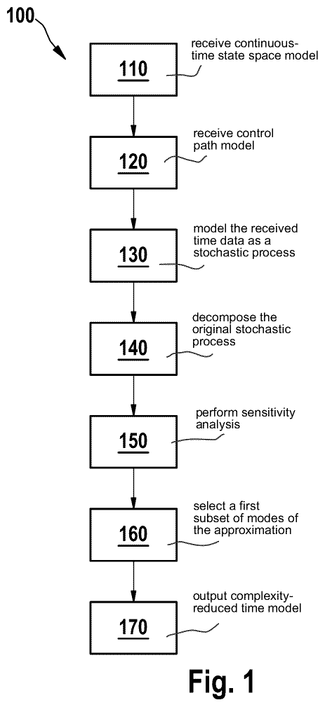

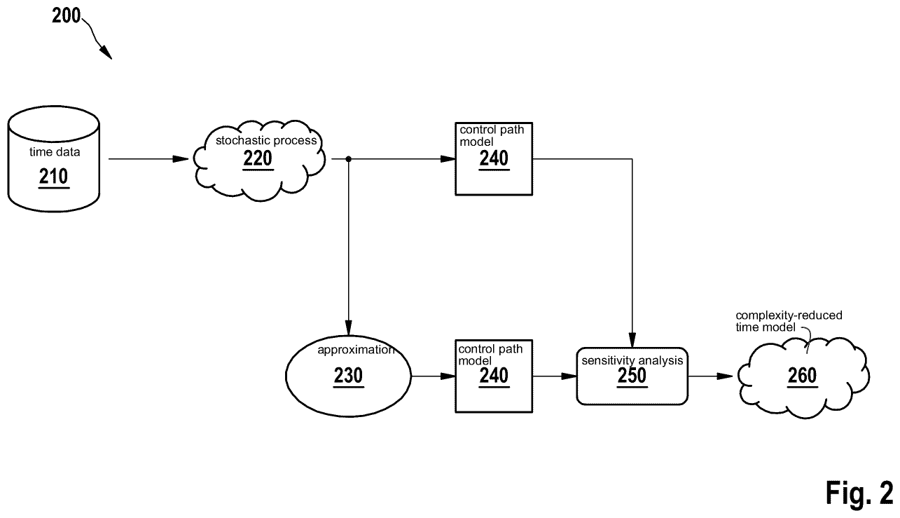

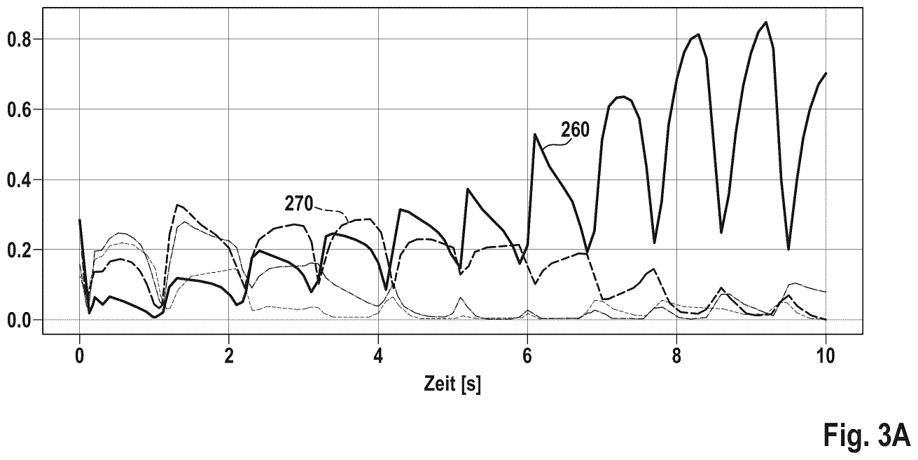

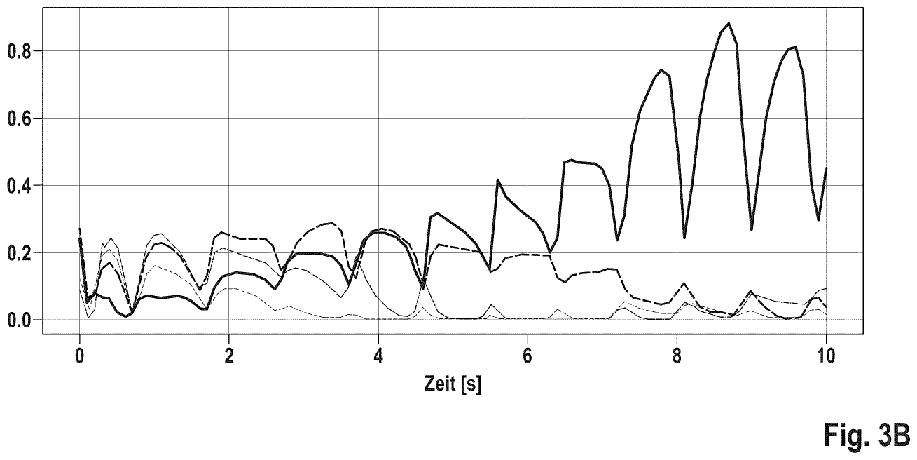

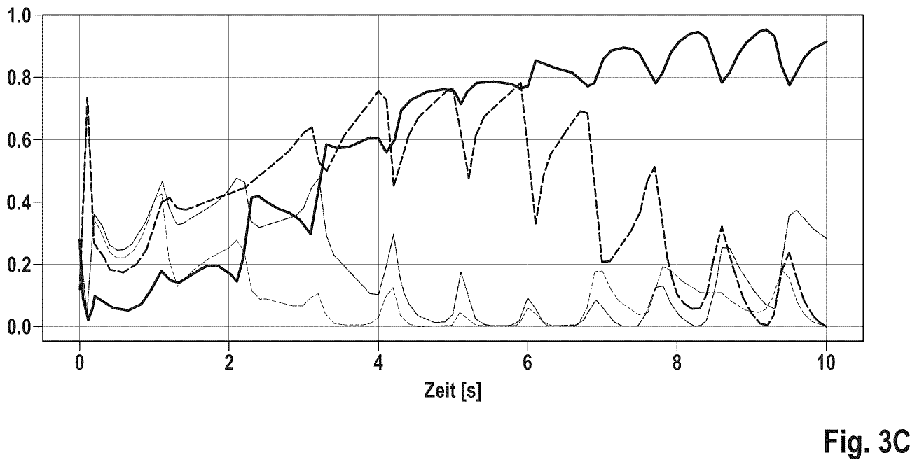

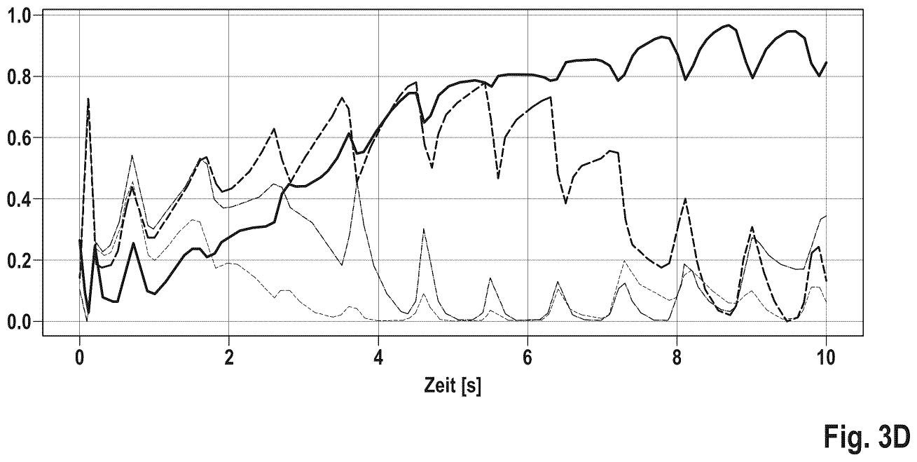

Firstly, the techniques of the present disclosure are discussed with reference to FIG. 1 and FIG. 2. Possible results and advantages that result from the method disclosed herein for generating a complexity-reduced time model are discussed with reference to FIG. 3A to 3D.

FIG. 1 is a flowchart showing possible steps of the method 100 for generating a complexity-reduced time model of a distributed system.

The method 100 for generating a complexity-reduced time model of a distributed system comprises receiving 110 a continuous-time state space model for describing a system 10 to be controlled. The method 100 comprises receiving 110 time data 210, receiving 120 a control path model 240 and modeling 130 the received time data as a stochastic process 220, in order to obtain an original stochastic process. The method furthermore comprises decomposing 140 the original stochastic process into a plurality of modes of the original stochastic process, in order to obtain an approximation 230 of the original stochastic process. The method comprises performing 150 a sensitivity analysis 250 using the control path model 240 and the approximation. The method furthermore comprises selecting 160 a first subset of modes of the approximation on the basis of the comparison and/or a default value, and outputting 170 a complexity-reduced time model 260 on the basis of the first subset of the modes.

In an example, the method comprises designing a state controller on the basis of the complexity-reduced time model 260. In an example, the method comprises applying the state controller in a function for controlling and/or monitoring a vehicle and/or a robot.

In some examples, the received time data 210 can comprise transmission times obtained by measuring or simulating a transmission of data between components of a distributed system. In examples, the components of the distributed system can comprise controller components. In examples, the components can comprise sensors, state controllers, and/or actuators. In examples, the components can comprise computer programs implemented in the form of software. In examples, the computer programs can each be executed in a cloud, an edge, or on a local computer system, such as a control unit. In examples, the time data 210 can comprise time records of communication protocols between the components of the distributed system. In examples, a virtual simulation of the distributed system can be performed in order to obtain the time data 220. In some examples, the time data 210 can be obtained by measurement in a real-world distributed system.

In examples, decomposing 140 the original stochastic process 220 into a plurality of modes of the original stochastic process can be based on a Karhunen-Loeve expansion. In examples, the following can apply to the decomposition:

$${X}_{trunc}^{N} ( t , ω ) = {\sum }_{i = 1}^{N} \sqrt{{λ}_{i}} {ζ}_{i} ( ω ) {e}_{i} ( t )$$

In this example, X_{trunc}^{N}(t,ω) corresponds to the approximation 230 of the original stochastic process. In this example, λᵢ corresponds to the eigenvalue of each mode, ζᵢ(ω) corresponds to an independent random variable, and eᵢ(t) corresponds to the eigenvector of each mode. For example, at the limit value N→∞, X_{trunc}^{N}(t,ω) corresponds to the original stochastic process. In examples, the first subset of modes can comprise a number N of modes. For example, decomposing the original stochastic process into the plurality of modes can be advantageous in order to utilize a possible correlation between the individual time data.

In some examples, the influence of the modes of the first subset on the approximation 230 of the original stochastic process can be greater than the influence of the modes of a second subset of the approximation 230 whose modes are not part of the first subset, and wherein the default value comprises a threshold value associated with the influence of the modes. For example, the method can comprise an analysis of how sensitively certain modes, into which the original stochastic process is decomposed, respond to changes.

In some examples, the sensitivity analysis 250 can comprise performing a comparison of the approximation 230 and the original stochastic process 220 using the control path model 240. FIG. 3A to 3D show sensitivities of individual modes of the original stochastic process. FIG. 3A to 3D show some modes of the plurality of modes of the stochastic process in a control system during a group start (so-called traffic light start) of a plurality of vehicles. The control path model 240 can be part of the control system. In this example, a target acceleration is specified for each vehicle following in a convoy of vehicles. The delay in the feedback loop (feedback delay) of the acceleration control is represented as a stochastic process in the model, and its modes are used as uncertain parameters in a subsequent UQ experiment. Target variables in the present analysis are the distance (FIG. 3A, 3C) and the relative velocity (FIG. 3B, FIG. 3D) to the preceding vehicle. In examples, the target variable can comprise the manipulated variable of the control system. In the diagrams, the delay in seconds is plotted on the horizontal axis (x-axis) and the sensitivity of the modes is plotted on the vertical axis (y-axis). For example, it can be seen that mode 1 responds more sensitively to changes than mode 2, so that the influence of mode 1 on the overall process is greater or mode 1 is more relevant for simulating the stochastic process than mode 2. The first subset of modes can comprise the modes that simulate the stochastic process better, i.e., with smaller deviation, than the modes of the second subset.

In examples, selecting the first subset of modes can comprise determining a scalar characteristic variable from the time curves of the approximation. In examples, the characteristic variable can comprise the normalized area under the corresponding curves. For example, normalization can be performed on the sum of all areas, and it is thus possible to select the modes whose sum exceeds a certain threshold value. In examples, the default value can comprise this threshold value. In examples, the modes whose area sum results in a specific percentage can be combined into the first subset. In examples, the default value can comprise the specific percentage. In examples, selecting the first subset of modes can comprise determining an approximation error. In examples, the approximation error between iteratively combined individual modes of the plurality of modes and the original stochastic process can be determined. In examples, one or more modes can be added in each iteration step and the approximation error between the original stochastic process and the modes combined in each step (as a whole) can be determined. In examples, this approximation error can converge toward a value and/or stabilize. In examples, the modes combined in each iteration step can result in a stochastic process that has an approximation error to the original stochastic process.

In examples, performing 150 the sensitivity analysis can comprise at least two simulations of a control using the received control path model 240. In examples, a first simulation can be performed on the basis of the original stochastic process 220 in order to obtain a first simulation result. In examples, a second simulation can be performed on the basis of the approximation 230. For example, the first subset can comprise modes of the approximation whose simulation result is more similar to the first simulation result than a simulation result of a second subset of the approximation whose modes are not part of the first subset. In examples, an error value between the first simulation result and the simulation result of the second subset can be calculated. In examples, the first subset can be selected 160 on the basis of a threshold value for the error value. In examples, the modes can be selected according to their influence on the target variables, for example as described above with reference to FIG. 3A to FIG. 3D. For example, the modes whose cumulative sensitivity exceeds a threshold value can be selected. For example, Sᵢ can be the sensitivity of a mode. Furthermore, S_{cum} Can be the sum of all determined sensitivities and a can be a threshold value. Then: Σ_{i∈I}_{ₛₑₗ}Sᵢ≥S_{cum}·α if Iₛₑₗ comprises the index set of the selected sensitivities. In examples, the threshold α is equal to 0.9. In examples, the threshold α is equal to 0.92, . . . , 0.95, . . . 0.98. For example, it is not important that the sensitivities follow the sequence 1, 2, 3, . . . . In examples, the chosen sensitivities can comprise any index. As already described above, the target variables can comprise the manipulated variables of the control. For example, the target variables for a longitudinal control of two vehicles can comprise the distance between the vehicles and/or the relative velocity.

In examples, modeling 130 the received time data 210 as a stochastic process 220 can be performed on the basis of a Gaussian process regression.

In examples, the received time data 210 can comprise transmission times obtained by measuring or simulating a transmission of data between components of a distributed system. In examples, the original stochastic process 220 can be used to model time effects, wherein the time effects comprise at least one of jitter, delay, and/or degradation. In examples, the complexity-reduced time model 260 can be used for controlling and/or regulating a vehicle function, a robot function, a building automation function, a power tool automation function, and/or a home appliance automation function.

In examples, the distributed system can comprise a system to be controlled and components for controlling the system. In examples, components of the distributed system can be arranged in a cloud, an edge or in local entities such as a vehicle, a robot, a building, a household appliance, or a power tool. In examples, the time effects can arise from the data transmission between the components of the distributed system. In examples, the time effects can arise from the data transmission between the system to be controlled and the components for controlling the system.

In examples, the method can comprise designing a state controller by means of the complexity-reduced time model 260. In examples, the design of the state controller can be based on an intrusive uncertainty quantification. In examples, the method can comprise installing the complexity-reduced time model 260 on a computer system of a vehicle, a robot, a building, a power tool, and/or a household appliance. In examples, the method can comprise using the complexity-reduced time model 260 for controlling. In examples, the method can comprise using the complexity-reduced time model 260 for controlling at runtime. In examples, the method can comprise using the complexity-reduced time model 260 for controller design, observer design and/or model-predictive control. The method can also comprise determining the manipulated variables of a control by means of the complexity-reduced time model 260.

In examples, the complexity-reduced time model 260 can be used for controlling and/or regulating a vehicle function (in particular, for controlling a driving function). For example, the vehicle function can be a function for autonomous and/or assisted driving. In some examples, the complexity-reduced time model can be suitable to be executed on a computer system of a vehicle (for example an autonomous, highly automated or assisted driving vehicle). For example, the computer system can be implemented locally in the vehicle or (at least partially) in a backend that is communicatively connected to the vehicle. For example, the computer system can comprise a control unit on which the complexity-reduced time model 260 is implemented and/or used. In some examples, the vehicle can comprise a computer system with a communication interface which allows communication with a backend. For example, the complexity-reduced time model 260 can be implemented and/or used in this backend.

In examples, the time effects can arise from the data transmission between a system to be controlled and the computer system that, for example, executes a state controller. In one example, the system to be controlled can be a system for transverse guidance and/or longitudinal guidance of the vehicle. In examples, a state variable vector of a control can be based on velocity information or distance information. In examples, the state variable vector can have a time dependence that is described by means of the complexity-reduced time model 260. In examples, the state variable vector can comprise a relative velocity and/or a distance between a first vehicle, a second vehicle, a person and/or a stationary object. In one example, a state variable vector of an associated state space model can comprise variables based on at least one of a steering angle, an orientation angle, a yaw rate, a slip angle, and/or a lateral error. In examples, the state variable vector can comprise information from a network, such as motion information and/or direction information from other vehicles. In examples, this information can be provided by means of vehicle-to-vehicle communication (V2V communication) or by means of a backend (V2X communication). In one example, an input variable of an input variable vector can comprise a steering speed or target specifications for acceleration processes and/or braking processes. In examples, the system to be controlled can be designed to be arranged in a drive control or a drive unit and/or can be used for controlling a motor-related function (in particular, for motor control). In examples, the system to be controlled can be designed to be arranged in a drive control of an electric machine. For example, the state vector of the state space model can contain variables based on at least one of a control signal, an operating mode or a power setting of the electric machine.

The present disclosure also relates to methods for controlling and/or regulating a robot using a complexity-reduced time model 260 generated by means of the methods of the present disclosure.

In other examples, the complexity-reduced time model 260 can be used for controlling and/or regulating a robot function (in particular, for controlling a motion function of a robot). For example, the robot function can be a function for transverse guidance and/or longitudinal guidance of the robot. In some examples, the complexity-reduced time model 260 can be executed on a computer system of a robot. For example, the computer system can be locally implemented in the robot or (at least partially) in a backend that is communicatively connected to the robot. In some examples, the complexity-reduced time model 260 can be executed in a backend. In examples, a state variable vector of a robot control can be based on velocity information or distance information. In examples, the state variable vector can have a time dependence that can be described by means of the complexity-reduced time model 260. In examples, the state variable vector can comprise a relative velocity and/or a distance between a first robot, a person, another mobile device and/or a stationary object. In one example, a state variable vector of an associated state space model can comprise variables based on at least one of a steering angle, an orientation angle, a yaw rate, a slip angle, and/or a lateral error. In examples, the state variable vector can comprise information from a network, such as motion information and/or direction information from other robots, mobile devices and/or people. In examples, this information can be provided by means of direct communication or by means of a backend. In one example, an input variable of an input variable vector can comprise a steering speed or target specifications for acceleration processes and/or braking processes.

The present disclosure also relates to methods for controlling and/or regulating functions in building automation using a complexity-reduced time model 260 generated by means of the methods of the present disclosure.

In one example, the complexity-reduced time model 260 can be used for controlling building functions (in particular, for controlling building automation functions). For example, the building function can be a function for controlling room temperature, lighting and/or security equipment. In some examples, the complexity-reduced time model 260 can be suitable to be executed on a computer system within the building. For example, the computer system can be locally implemented in the building or (at least partially) in a backend that is communicatively connected to the building. For example, the computer system can comprise a control system or a building automation control unit on which the complexity-reduced time model 260 can be executed. In examples, the building can have a computer system with a communication interface that makes communication with an external backend possible. For example, the complexity-reduced time model 260 can be executed in this backend. In examples, the time effects can arise from the data transmission between a system to be controlled and the computer system executing a state controller. In examples, a state variable vector of an associated state space model can contain variables based on information such as room temperature, brightness or presence of people. In some cases, the state variable vector can comprise a relative temperature difference, illuminance or distance to a specific location or object in the building. In examples, the state variable vector can have a time dependence that can be described by means of the complexity-reduced time model 260. An example of a state variable vector in the context of building automation could contain variables based on parameters such as heating control, lighting settings, ventilation speed or security alarms. In examples, information can come from a network, such as sensor data or settings of other buildings or building components. This information can be provided through communication between buildings or parts of buildings or via an external backend. In one example, an input variable of the input variable vector could comprise, for example, a temperature specification and/or a lighting specification, for example in the form of a voltage signal and/or current signal.

A computer system designed to execute the method 100 for generating a complexity-reduced time model of a distributed system is also disclosed. The computer system can comprise at least one processor and/or at least one working memory. The computer system can furthermore comprise a (non-volatile) memory. In examples, all steps of the method 100 can be executed by the computer system. In some examples, individual steps of the method 100 can be executed by the computer system. Optionally, results of individual method steps that are not executed by the computer system can be received by the computer system.

Also disclosed is a computer program designed to execute the method 100 for generating a complexity-reduced time model of a distributed system. The computer program can be present, for example, in interpretable or in compiled form. For execution, it can (even in parts) be loaded into the RAM of a computer, for example as a bit or byte sequence.

A computer-readable medium or signal that stores and/or contains the computer program or at least a portion thereof is also disclosed. The medium can comprise, for example, one of RAM, ROM, EPROM, HDD, SDD, . . . , on/in which the signal is stored.

1-12. (canceled)

13. A computer-implemented method for generating a complexity-reduced time model of a distributed system, the method comprising the following steps:
receiving time data;
receiving a control path model;
modeling the received time data as a stochastic process to obtain an original stochastic process;
decomposing the original stochastic process into a plurality of modes of the original stochastic process to obtain an approximation of the original stochastic process;
performing a sensitivity analysis using the control path model and the approximation;
selecting a first subset of modes of the approximation based on a comparison and/or a default value; and
outputting a complexity-reduced time model based on the first subset of the modes.

14. The computer-implemented method according to claim 13, wherein an influence of the modes of the first subset on the approximation of the original stochastic process is greater than an influence of the modes of a second subset of the approximation whose modes are not part of the first subset, and wherein the default value includes a threshold value associated with the influence of the modes.

15. The computer-implemented method according to claim 13, wherein the sensitivity analysis includes performing a comparison of the approximation and the original stochastic process using the control path model.

16. The computer-implemented method according to claim 13, wherein the performing of the sensitivity analysis includes at least two simulations of a control using the received control path model,
wherein a first simulation of the at least two simulations is performed based on the original stochastic process to obtain a first simulation result, and a second simulation of the at least two simulations is performed based on the approximation, and
wherein the first subset includes modes of the approximation whose simulation result is more similar to the first simulation result than a simulation result of a second subset of the approximation whose modes are not part of the first subset.

17. The computer-implemented method according to claim 13, wherein the decomposing of the original stochastic process into a plurality of modes of the original stochastic process is based on a Karhunen-Loève expansion.

18. The computer-implemented method according to claim 13, wherein the modeling of the received time data as a stochastic process is performed based on a Gaussian process regression.

19. The computer-implemented method according to claim 13, wherein the received time data include transmission times obtained by measuring or simulating a transmission of data between components of a distributed system.

20. The computer-implemented method according to claim 13, wherein the original stochastic process is used to model time effects, wherein the time effects include at least one of jitter, and/or delay, and/or degradation.

21. The computer-implemented method according to claim 13, wherein the complexity-reduced time model is used for controlling and/or regulating: a vehicle function, and/or a robot function, and/or a building automation function, and/or a power tool automation function, and/or a home appliance automation function.

22. A computer system configured to generate a complexity-reduced time model of a distributed system, the computer system configured to:
receive time data;
receive a control path model;
model the received time data as a stochastic process to obtain an original stochastic process;
decompose the original stochastic process into a plurality of modes of the original stochastic process to obtain an approximation of the original stochastic process;
perform a sensitivity analysis using the control path model and the approximation;
select a first subset of modes of the approximation based on a comparison and/or a default value; and
output a complexity-reduced time model based on the first subset of the modes.

23. A non-transitory computer-readable medium on which is stored a computer program including comments for generating a complexity-reduced time model of a distributed system, the commands, when executed by a computer system causing the computer system to perform the following steps:
receiving time data;
receiving a control path model;
modeling the received time data as a stochastic process to obtain an original stochastic process;
decomposing the original stochastic process into a plurality of modes of the original stochastic process to obtain an approximation of the original stochastic process;
performing a sensitivity analysis using the control path model and the approximation;
selecting a first subset of modes of the approximation based on a comparison and/or a default value; and
outputting a complexity-reduced time model based on the first subset of the modes.
